(19) United States
(12) Patent Application Publication
(10) Pub. No.: US 2017/0340501 A1
(43) Pub. Date: Nov. 30, 2017

(54) MULTI-ANGLE MASSAGE DEVICE

(71) Applicant: HON HAI PRECISION INDUSTRY CO., LTD., New Taipei (TW)

(72) Inventors: SHIH-PIN LIN, New Taipei (TW); TING-YI LIAO, New Taipei (TW); TSUNG-JU WU, New Taipei (TW); FU-HSIN CHIU, New Taipei (TW); YI-CHENG LIN, New Taipei (TW); HSIN-PEI HSIEH, New Taipei (TW); CHUN-CHI LIN, New Taipei (TW); CHANG-DA HO, New Taipei (TW); KAI-JIE CHAN, New Taipei (TW)

(21) Appl. No.: 15/240,032

(22) Filed: Aug. 18, 2016

(30) Foreign Application Priority Data
May 24, 2016 (TW) 105116076

(51) Int. Cl. A61H 1/00; A61H 23/00

(52) U.S. Cl. CPC A61H 1/008; A61H 23/00; A61H 2201/5043

(57) ABSTRACT

A massage device includes a housing, and a first driving assembly, a second driving assembly, and a massage assembly received in the housing. The first driving assembly includes a first driving motor. The second driving assembly includes a second driving motor mounted to the housing, and a shaft handle mounted to the second driving motor and abutting against a bottom surface of the second end. The massage assembly includes a fixing frame and a massager received in the fixing frame. The fixing frame includes a first end pivotally connected to the housing and an opposite second end. The first driving motor can drive the massager reciprocally. The second driving motor can drive ends of the shaft handle to move circumferentially, thereby causing the second end to move back and forth perpendicular to the extending direction.

### FIELD

The subject matter herein generally relates to health-promoting devices.

### BACKGROUND

Sexual massagers are used to stimulate sexual pleasure. However, the massager is usually cumbersome to manipulate. Furthermore, the massager can only provide stimulation along one single direction, which cannot satisfy the actual needs of the users.

### BRIEF DESCRIPTION OF THE DRAWINGS

Implementations of the present technology will now be described, by way of example only, with reference to the attached figures.

FIG. 1 is an isometric view of an exemplary embodiment of a multi-angle massage device.

FIG. 2 is an exploded, isometric view of the multi-angle massage device of FIG. 1.

FIG. 3 is a cross-sectional view taken along line of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

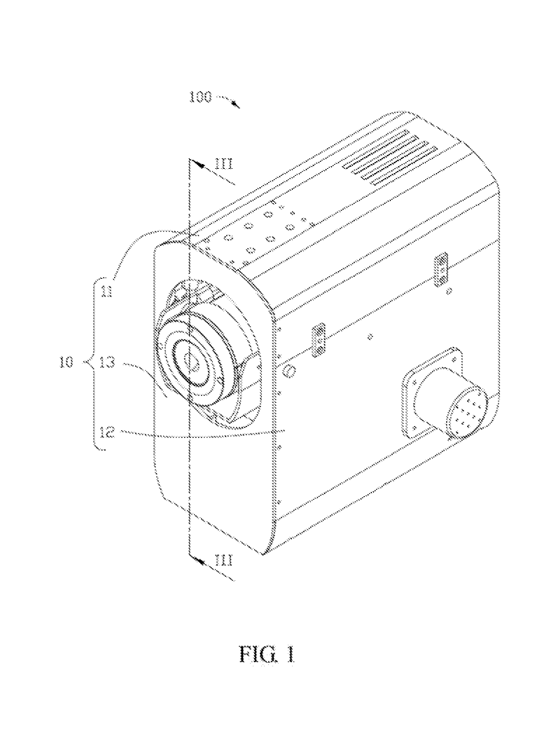

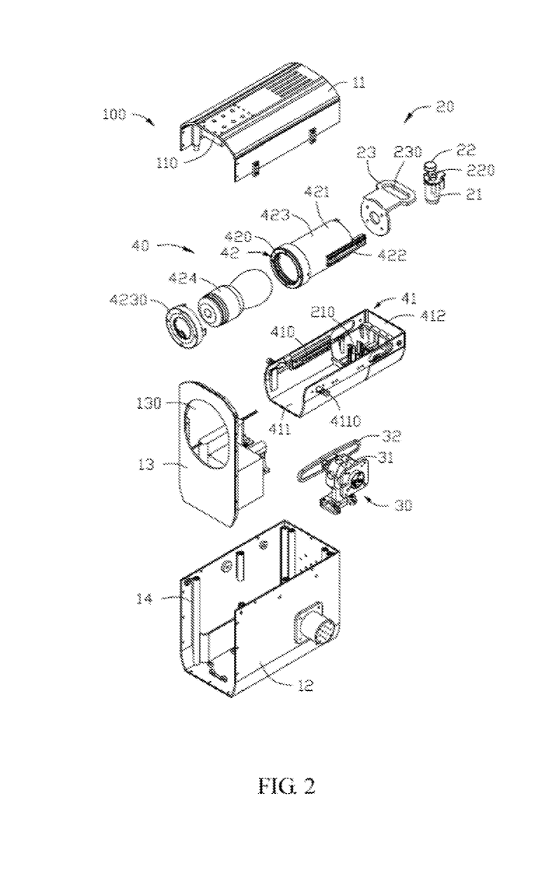

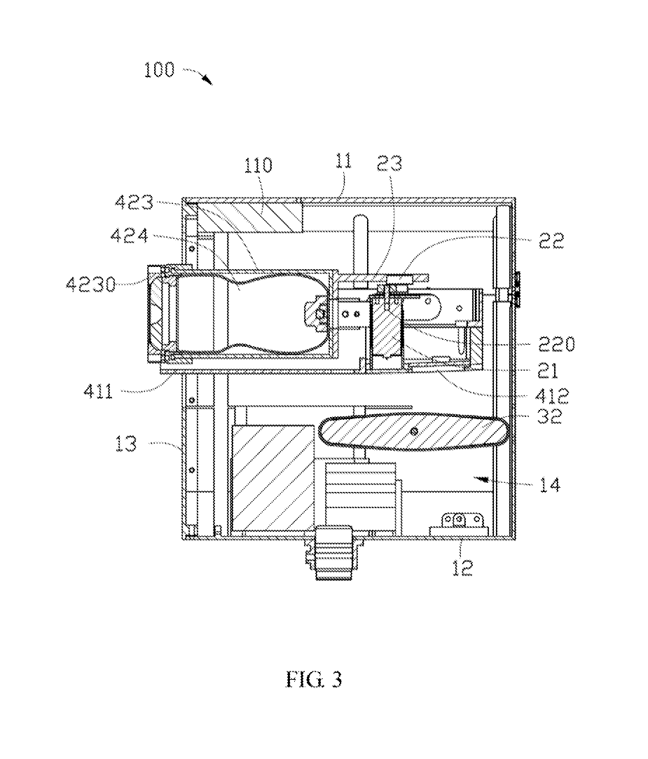

FIGS. 1-3 illustrate an exemplary embodiment of a multi-angle massage device 100 comprising a housing 10, a first driving assembly 20, a second driving assembly 30, and a massage assembly 40.

The housing 10 is hollow and defines a receiving space 14. The first driving assembly 20, the second driving assembly 30, and the massage assembly 40 are received in the receiving space 14. In at least one exemplary embodiment, the housing 10 comprises an upper portion 11, a lower portion 12, and a cover 13. The upper portion 11, the lower portion 12, and the cover 13 cooperatively define the receiving space 14. The cover 13 defines a through hole 130. The massage assembly 40 protrudes out of the housing 10 via the through hole 130.

The massage assembly 40 comprises a fixing frame 41 and a massager 42. The massager 42 is received in the fixing frame 41, and can slide in the fixing frame 41 along an extending direction of the fixing frame 41. The massager 42 is configured to be applied to a body part of a user. The fixing frame 41 is substantially a semi-cylinder, and comprises a first end 411 and an opposite second end 412. The first end 411 protrudes out of the housing 10 via the through hole 130. A connection shaft 4110 is located on each of two opposite sides of the first end 411. An end of each connection shaft 4110 far away from the first end 411 is secured to an inner surface of the lower portion 12, thereby pivotally connecting the first end 411 to the lower portion 12. In at least one exemplary embodiment, the fixing frame 41 comprises a sliding rail 420 positioned between the first end 411 and the second end 412 and parallel to the extending direction of the fixing frame 41. The massager 42 comprises a sliding block 422 which substantially matches the sliding rail 420 in shape. The sliding block 422 can slide along the sliding rail 420, thereby allowing the massager 42 to slide along the extending direction of the fixing frame 41. The massager 42 is a substantially hollow cylinder, and comprises a third end 420 and an opposite fourth end 421. The third end 420 and the fourth end 421 respectively correspond to the first end 411 and the second end 412. The third end 420 protrudes out of the housing 10 via the through hole 130.

The first driving assembly 20 is secured in the fixing frame 41, and comprises a first driving motor 21, a wheel 22, and a connection socket 23. The first driving motor 21 is secured in the fixing frame 41 via a mounting base 210. The wheel 22 is secured to a top of the first driving motor 21 via a wheel shaft 220 of the wheel 22. The connection socket 23 defines a receiving slot 230 for receiving the wheel 22. An end of the connection socket 23 is connected to the fourth end 421 of the massager 42. When the first driving motor 21 rotates, the wheel 22 rotates along an axis substantially parallel to the wheel shaft 220 and the first driving motor 21. The massager 42 is driven by the wheel 22 to slide in a reciprocating manner along the extending direction of the fixing frame 41 via the connection socket 23. As such, the third end 420 of the massager 42 can move in a reciprocating manner via the through hole 130.

The second driving assembly 30 comprises a second driving motor 31 and a shaft handle 32. The second driving motor 31 is mounted to a bottom surface of the lower portion 12. A center of the shaft handle 32 is mounted to the second driving motor 31. Two ends of the shaft handle 32 successively abut against a bottom surface of the second end 412 of the fixing frame 41 when the second driving motor 31 is rotating. The second driving motor 31 can drive the ends of the shaft handle 32 to move circumferentially, thereby causing the second end 412 of the fixing frame 41 to move in a reciprocating manner along a direction perpendicular to the extending direction of the fixing frame 41. As such, the fourth end 421 of the massager 42 can move in a reciprocating manner along the direction perpendicular to the extending direction of the fixing frame 41. In at least one exemplary embodiment, an elastic member (not shown) is connected to each opposite side of the second end 412. An end of each elastic member far away from the second end 412 is mounted to the bottom surface of the lower portion 12, the elastic members thus limit a moving range of the second end 412.

In at least one exemplary embodiment, the massager 42 comprises a fixing portion 423 and a massager body 424. The fixing portion 423 is substantially a hollow cylinder, and comprises the third end 420 and the fourth end 421. The massager body 424 is received in the fixing portion 423. In at least one exemplary embodiment, the fixing portion 423 further comprises an upper cover 4230 which covers an opening of the fixing portion 423, thereby preventing the massager body 424 from disengaging from the fixing portion 423 when in use. In at least one exemplary embodiment, the massager body 424 may be a masturbation cup or a silicone casing.

In at least one exemplary embodiment, the device 100 further comprises a vibration motor (not shown) which is mounted to the fourth end 421 of the fixing portion 423 and which contacts an end of the massager body 424. The vibration motor can stimulate the body part by vibration.

In at least one exemplary embodiment, the device 100 further comprises a controller 110 received in the receiving space 14. In at least one exemplary embodiment, the controller 110 is secured to the upper portion 11. The controller 110 is configured to control the device 100 to perform a function when the massage device 10 receives an input from the user. For example, the relevant functions may be powering on the first motor 20, the second motor 30, and/or the vibration motor, and adjusting a vibration speed of the first motor 20, the second motor 30, and/or the vibration motor. This provides the user with different experiences. In at least one exemplary embodiment, the upper portion 11 comprises a display panel (not shown) which is electrically connected to a controller 110. The display panel has several mechanical or virtual keys for user input.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments, to the full extent indicated by the plain meaning of the terms in which the appended claims are expressed.

What is claimed is:

1. A multi-angle massage device comprising:
a housing, the housing defining a receiving space;
a first driving assembly, the first driving assembly received in the receiving space, and comprising a first driving motor;
a second driving assembly, the second driving assembly received in the receiving space, and comprising a second driving motor mounted to the housing, and a shaft handle mounted to the second driving motor and abutting against a bottom surface of the second end; and
a massage assembly, the massage assembly received in the receiving space, and comprising a fixing frame and a massager, the first driving assembly and the massager received in the fixing frame, the fixing frame comprising a first end and an opposite second end, the first end pivotally connected to the housing; and
wherein the first driving motor is configured to drive the massager to slide in a reciprocating manner along an extending direction of the fixing frame, the second driving motor is configured to drive ends of the shaft handle to move circumferentially, thereby causing the second end to move in a reciprocating manner along a direction perpendicular to the extending direction of the fixing frame, thus causing the massager to move in a reciprocating manner along the direction.

2. The multi-angle massage device of claim 1, wherein the massager comprises a third end and an opposite fourth end; the third end and the fourth end respectively correspond to the first end and the second end; the first driving assembly further comprises an wheel and a connection socket; the first driving motor is secured in the fixing frame via a mounting base; the wheel is secured to a top of the first driving motor via a wheel shaft of the wheel; the connection socket defines a receiving slot for receiving the wheel; an end of the connection socket is connected to the fourth end; the wheel rotates along an axis substantially parallel to the wheel shaft and the first driving motor when the first driving motor is rotating, thus driving the massager to slide in a reciprocating manner along the extending direction of the fixing frame via the connection socket.

3. The multi-angle massage device of claim 2, wherein the massager comprises a fixing portion and a massager body; the fixing portion comprises the third end and the fourth end; the massager body is received in the fixing portion and configured to be applied to a body part of a user.

4. The multi-angle massage device of claim 3, wherein the fixing portion further comprises an upper cover which covers an opening of the fixing portion.

5. The multi-angle massage device of claim 4 further comprising a controller received in the receiving space and configured to control the massage device to perform a function when the massage device receives an input.

6. The multi-angle massage device of claim 5, wherein the function comprises powering on at least one of the first motor and the second motor, and/or adjusting a vibration speed of at least one of the first motor and the second motor.

7. The multi-angle massage device of claim 1, wherein a connection shaft is located on each of two opposite sides of the first end; an end of each connection shaft far away from the first end is secured to an inner surface of the housing, thereby pivotally connecting the first end to the housing.

8. The multi-angle massage device of claim 1, wherein the fixing frame comprises a sliding rail positioned between the first end and the second end and parallel to the extending direction of the fixing frame; the massager comprises a sliding block able to slide along the sliding rail, thereby allowing the massager to slide along the extending direction of the fixing frame.

9. The multi-angle massage device of claim 1, wherein the housing comprises an upper portion, a lower portion, and a cover; the upper portion, the lower portion, and the cover cooperatively define the receiving space; the cover defines a through hole; the third portion protrudes out of the housing via the through hole, and moves in a reciprocating manner along the extending direction of the fixing frame via the through hole.

10. The multi-angle massage device of claim 1, wherein the massager body is a masturbation cup.

11. The multi-angle massage device of claim 1, wherein the massager body is a silicone casing.
